(19) United States
(12) Patent Application Publication
(10) Pub. No.: US 2024/0373501 A1
(43) Pub. Date: Nov. 7, 2024

(54) METHODS AND APPARATUSES FOR DETERMINING SIDELINK DRX CONFIGURATIONS

(71) Applicant: LENOVO (BEIJING) LIMITED, Beijing (CN)

(72) Inventors: Jie Hu, Beijing (CN); Jing Han, Beijing (CN); Haiming Wang, Beijing (CN); Lianhai Wu, Beijing (CN); Jie Shi, Beijing (CN); Ran Yue, Beijing (CN)

(21) Appl. No.: 18/291,412

(22) PCT Filed: Jul. 23, 2021
(86) PCT No.: PCT/CN2021/108212

§ 371 Date: Jan. 23, 2024

(51) Int. Cl. H04W 76/28; H04W 24/04; H04W 76/23; H04W 76/27; H04W 92/18

(52) U.S. Cl. CPC H04W 76/28; H04W 24/04; H04W 76/23; H04W 76/27; H04W 92/18

(57) ABSTRACT

The present application relates to methods and apparatuses for determining sidelink (SL) discontinuous reception (DRX) configurations. One embodiment of the present disclosure provides a method performed by a first user equipment (UE), including: transmitting, to a second UE, assistance information associated with an SL DRX configuration of the first UE, wherein the assistance information is comprised in an SL UE capability information message of the first UE that is also transmitted to the second UE, or comprised in a separate radio resource control (RRC) message that is also transmitted to the second UE; and receiving, from the second UE, an SL DRX configuration based on the assistance information that was sent to the second UE.

### TECHNICAL FIELD

The present disclosure generally relates to sidelink (SL) communications, and more specifically relates to methods and apparatuses for determining SL discontinuous reception (DRX) configurations.

### BACKGROUND OF THE INVENTION

Vehicle to everything (V2X) has been introduced into 5G wireless communication technology. In terms of a channel structure of V2X communication, a direct link between two user equipments (UEs) is called a sidelink (SL). Sidelink is a long-term evolution (LTE) feature introduced in the 3rd Generation Partnership Project (3GPP) Release 12, and enables a direct communication between proximal UEs, and data does not need to go through a base station (BS) or a core network.

In order to enhance the reliability of SL communications, it is desirable to determine SL DRX configurations before performing the SL communications.

### SUMMARY

Some embodiments of the present disclosure provide a method performed by a first UE, including: transmitting, to a second UE, assistance information associated with an SL DRX configuration of the first UE, wherein the assistance information is comprised in an SL UE capability information message of the first UE that is also transmitted to the second UE, or comprised in a separate radio resource control (RRC) message that is also transmitted to the second UE; and receiving, from the second UE, an SL DRX configuration based on the assistance information that was sent to the second UE.

In an embodiment of the present disclosure, the assistance information includes at least one of the following: a request for the SL DRX configuration; a Uu DRX configuration of the first UE; one or more DRX configurations for one or more other links of the first UE; one or more SL DRX configurations preferred or suggested by the first UE; or an acceptance or a rejection of an SL DRX configuration received from the second UE.

In an embodiment of the present disclosure, the assistance information is transmitted periodically.

In an embodiment of the present disclosure, the assistance information is transmitted in at least one of the following cases: when the first UE has one or more preferred SL DRX configurations; when the assistance information of the first UE is updated; when an operating state of the first UE changes; or when the first UE receives a request for the assistance information from the second UE.

In an embodiment of the present disclosure, the request for the assistance information includes a one-bit indication or a list of DRX configurations suggested by the second UE.

In an embodiment of the present disclosure, the assistance information comprised in the SL UE capability information message of the first UE includes a one-bit request for the SL DRX configuration, or an index of an SL DRX configuration suggested by the first UE.

In an embodiment of the present disclosure, the SL UE capability information message of the first UE includes an assistance information indicator indicating that the assistance information is to be transmitted in the separate RRC message.

In an embodiment of the present disclosure, the method further includes in the case that the SL DRX configuration is not applicable and one or more access stratum (AS) configurations received with the SL DRX configuration are applicable: transmitting, to the second UE, a radio resource control (RRC) reconfiguration failure message with an SL DRX configuration failure indication; applying a previous SL DRX configuration until a new RRC reconfiguration message is received; and applying the one or more AS configurations or continuing to apply previous one or more AS configurations until a new RRC reconfiguration message is received.

In an embodiment of the present disclosure, the method further includes in the case that the SL DRX configuration is applicable and one or more AS configurations received with the SL DRX configuration are not applicable: transmitting, to the second UE, an RRC reconfiguration failure message without an SL DRX configuration failure indication; applying previous one or more AS configurations until a new RRC reconfiguration message is received; and applying the SL DRX configuration or continuing to apply a previous SL DRX configuration until a new RRC reconfiguration message is received.

In an embodiment of the present disclosure, the method further includes in the case that the SL DRX configuration is not applicable and one or more AS configurations received with the SL DRX configuration are not applicable: transmitting, to the second UE, an RRC reconfiguration failure message with an SL DRX configuration failure indication; and continuing to apply a previous SL DRX configuration and previous one or more AS configurations until a new RRC reconfiguration message is received.

In an embodiment of the present disclosure, the method further includes in the case that the SL DRX configuration is applicable and one or more AS configurations received with the SL DRX configuration are applicable: transmitting, to the second UE, an RRC reconfiguration complete message; and applying both the SL DRX configuration and the one or more AS configurations.

In an embodiment of the present disclosure, the SL DRX configuration failure indication includes an SL DRX configuration failure cause.

In an embodiment of the present disclosure, the method further includes transmitting, to the second UE, updated assistance information in the case that the SL DRX configuration is not applicable.

In an embodiment of the present disclosure, the method further includes receiving, from the second UE, an updated SL DRX configuration in response to the SL DRX configuration failure indication.

In an embodiment of the present disclosure, the first UE and the second UE support SL DRX communication.

Some embodiments of the present disclosure provide a method performed by a second UE, including: receiving, from a first UE, assistance information associated with an SL DRX configuration of the first UE, wherein the assistance information is comprised in an SL UE capability information message of the first UE that is also received from the first UE, or comprised in a separate radio resource control (RRC) message that is also received from the first UE; and transmitting, to the first UE, an SL DRX configuration based on the assistance information that was received from the first UE.

In an embodiment of the present disclosure, the assistance information includes at least one of the following: a request for the SL DRX configuration; a Uu DRX configuration of the first UE; one or more DRX configurations for one or more other links of the first UE; one or more SL DRX configurations preferred or suggested by the first UE; or an acceptance or a rejection of an SL DRX configuration received from the second UE.

In an embodiment of the present disclosure, the assistance information is received periodically.

In an embodiment of the present disclosure, the method further includes transmitting a request for the assistance information to the first UE.

In an embodiment of the present disclosure, the request for the assistance information includes a one-bit indication or a list of DRX configurations suggested by the second UE.

In an embodiment of the present disclosure, the assistance information comprised in the SL UE capability information message of the first UE includes a one-bit request for the SL DRX configuration, or an index of an SL DRX configuration suggested by the first UE.

In an embodiment of the present disclosure, the SL UE capability information message of the first UE includes an assistance information indicator indicating that the assistance information is to be received in the separate RRC message.

In an embodiment of the present disclosure, the method further includes receiving, from the first UE, an RRC reconfiguration failure message with an SL DRX configuration failure indication; and transmitting an updated SL DRX configuration to the first UE in response to the SL DRX configuration failure indication.

In an embodiment of the present disclosure, the method further includes transmitting, to a BS, at least one of the following: updated assistance information from the first UE; the SL DRX configuration failure indication; or an SL DRX configuration failure cause.

In an embodiment of the present disclosure, the SL DRX configuration failure indication received from the first UE includes the SL DRX configuration failure cause.

In an embodiment of the present disclosure, the request for the assistance information is transmitted when an operating state of the second UE changes.

In an embodiment of the present disclosure, the method further includes acquiring an updated SL DRX configuration when an operating state of the second UE changes; and transmitting the updated SL DRX configuration to the first UE when the updated SL DRX configuration is acquired.

In an embodiment of the present disclosure, the method further includes transmitting, to a BS, the assistance information received from the first UE to request the SL DRX configuration; and receiving the SL DRX configuration from the BS.

In an embodiment of the present disclosure, the SL DRX configuration is determined from a set of SL DRX configurations each corresponding to a respective quality of service (QoS) profile, or from a set of common SL DRX configurations.

In an embodiment of the present disclosure, the set of SL DRX configurations or the set of common SL DRX configurations are preconfigured in the second UE or received in a system information block (SIB) message.

In an embodiment of the present disclosure, the method further includes requesting to enter in an RRC-connected state upon receiving the assistance information in the case that the second UE is in an RRC-idle state or an RRC-inactive state.

Yet another embodiment of the present disclosure provides an apparatus, which includes: a processor; and a wireless transceiver coupled to the processor, wherein the processor is configured to: transmit, via the wireless transceiver, assistance information associated with an SL DRX configuration of the first UE, wherein the assistance information is comprised in an SL UE capability information message of the first UE that is also transmitted to the second UE, or comprised in a separate radio resource control (RRC) message that is also transmitted to the second UE; and receive, via the wireless transceiver, an SL DRX configuration based on the assistance information that was sent to the second UE.

Still another embodiment of the present disclosure provides an apparatus, which includes: a processor; and a wireless transceiver coupled to the processor, wherein the processor is configured to: receive, from a second apparatus via the wireless transceiver, assistance information associated with an SL DRX configuration of the first UE, wherein the assistance information is comprised in an SL UE capability information message of the first UE that is also received from the first UE, or comprised in a separate radio resource control (RRC) message that is also received from the first UE; and transmit, via the wireless transceiver, an SL DRX configuration based on the assistance information that was received from the first UE.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates an exemplary communication system according to some embodiments of the present disclosure;

FIG. 2 illustrates a flow chart of an exemplary sidelink unicast communication according to some embodiments of the present disclosure;

FIG. 3 illustrates a flow chart of another exemplary sidelink unicast communication according to some embodiments of the present disclosure;

FIG. 4A illustrates a flow chart of an exemplary method performed by a receiving (Rx) UE for wireless communication according to some embodiments of the present disclosure;

FIG. 4B illustrates a flow chart of an exemplary method performed by a transmitting (Tx) UE for wireless communication according to some embodiments of the present disclosure; and

FIG. 5 illustrates a simplified block diagram of an exemplary apparatus according to some embodiments of the present disclosure.

### DETAILED DESCRIPTION

The detailed description of the appended drawings is intended as a description of the preferred embodiments of the present invention, and is not intended to represent the only form in which the present invention may be practiced. It should be understood that the same or equivalent functions may be accomplished by different embodiments that are intended to be encompassed within the spirit and scope of the present invention.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

UE(s) under new radio (NR) V2X scenario may be referred to as V2X UE(s). A V2X UE, which transmits data according to sidelink resource(s) scheduled by a BS or selected by itself, may be referred to as a UE for transmitting, a transmitting UE, a transmitting V2X UE, a Tx UE, a V2X Tx UE, an SL Tx UE, or the like. A V2X UE, which receives data according to sidelink resource(s) scheduled by a BS or selected by a Tx UE, may be referred to as a UE for receiving, a receiving UE, a receiving V2X UE, an Rx UE, a V2X Rx UE, an SL Rx UE, or the like.

V2X UE(s) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like.

According to some embodiments of the present application, V2X UE(s) may include a portable wireless communication device, a smart phone, a cellular telephone, a flip phone, a device having a subscriber identity module, a personal computer, a selective call receiver, or any other device that is capable of sending and receiving communication signals on a wireless network.

According to some embodiments of the present application, V2X UE(s) includes wearable devices, such as smart watches, fitness bands, optical head-mounted displays, or the like. Moreover, V2X UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. V2X UE(s) may communicate directly with BS(s) via uplink (UL) communication signals.

A BS under NR V2X scenario may be referred to as a base unit, a base, an access point, an access terminal, a macro cell, a Node-B, an enhanced Node B (eNB), a gNB, a Home Node-B, a relay node, a device, a remote unit, or by any other terminology used in the art. A BS may be distributed over a geographic region. Generally, a BS is a part of a radio access network that may include one or more controllers communicably coupled to one or more corresponding base stations.

A BS is generally communicably coupled to one or more packet core networks (PCN), which may be coupled to other networks, like the packet data network (PDN) (e.g., the Internet) and public switched telephone networks, among other networks. These and other elements of radio access and core networks are not illustrated but are well known generally by those having ordinary skills in the art. For example, one or more BSs may be communicably coupled to a mobility management entity (MME), a serving gateway (SGW), and/or a packet data network gateway (PGW).

A BS may serve a number of V2X UEs within a serving area, for example, a cell or a cell sector via a wireless communication link. A BS may communicate directly with one or more V2X UEs via communication signals. For example, a BS may serve V2X UEs within a macro cell.

SL communication between a Tx UE and an Rx UE under NR V2X scenario includes groupcast communication, unicast communication, or broadcast communication.

Embodiments of the present application may be provided in a network architecture that adopts various service scenarios, for example but is not limited to, 3GPP 3G, LTE, LTE-Advanced (LTE-A), 3GPP 4G, 3GPP 5G NR, 3GPP LTE Release 12 and onwards, etc. It is contemplated that along with the 3GPP and related communication technology development, the terminologies recited in the present application may change, which should not affect the principle of the present application.

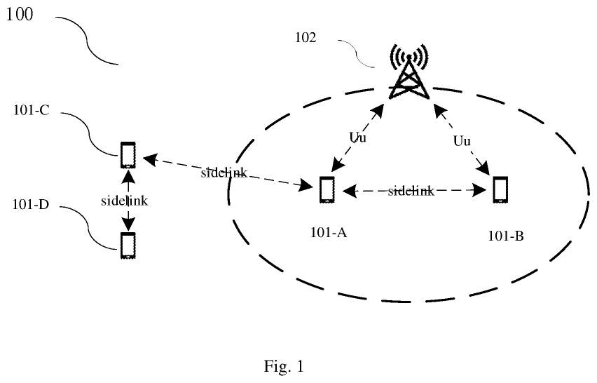

FIG. 1 illustrates an exemplary communication system 100 according to some embodiments of the present application.

As shown in FIG. 1, the communication system 100 includes a base station, e.g., BS 102, and some UEs, e.g., UE 101-A, UE 101-B, UE 101-C, and UE 101-D. It is contemplated that, in accordance with some other embodiments of the present application, a communication system may include more BSs and/or more or fewer UEs. Moreover, it is contemplated that names of UEs (which represent a Tx UE, an Rx UE, and etc.) as illustrated and shown in FIG. 1 may be different. The UEs may communicate with each other via sidelink.

In addition, although each UE as shown in FIG. 1 is illustrated in the shape of a smart phone, it is contemplated that a communication system may include any type of UEs (e.g., a roadmap device, a cell phone, a computer, a laptop, IoT (internet of things) device or other type of devices) in accordance with some other embodiments of the present application.

According to some embodiments of the present disclosure, UE 101-A may function as a Tx UE, and UE 101-B and UE 101-C may function as Rx UEs. UE 101-A may exchange messages with UE 101-B or UE 101-C through a sidelink, for example, via a PC5 interface as defined in 3GPP TS 23.303. UE 101-A may transmit information or data to other UE(s) within the communication system through SL unicast, SL groupcast, or SL broadcast. For instance, UE 101-A may transmit data to UE 101-B in an SL unicast transmission session. UE 101-A may transmit data to UE 101-B and UE 101-C in a groupcast group by an SL groupcast transmission session. Also, UE 102 may transmit data to UE 101-B and UE 101-C by an SL broadcast transmission session.

According to some other embodiments of the present disclosure, UE 101-B may function as a Tx UE and transmit messages, and UE 101-A may function as an Rx UE and receive the messages from UE 101-B.

Both UE 101-A and UE 101-B in the example shown in FIG. 1 may transmit information or data to BS 102 and receive control information or data from BS 102, for example, via an NR Uu interface. BS 102 may define one or more cells, and each cell may have a coverage area. As shown in FIG. 1, both UE 101-A and UE 101-B are within a coverage area of BS 102, and UE 101-C and UE 101-D are out of the coverage area of BS 102.

BS 102 as illustrated and shown in FIG. 1 is not a specific base station, but may be any base station(s) in the communication system. For example, if the communication system includes two BSs 102, UE 101-A being within a coverage area of any one of the two BSs 102 may be called as a case that UE 101-A is within coverage of BS 102 in the communication system; and only UE 101-A being outside of coverage area(s) of both BSs 102 can be called as a case that UE 101-A is outside of coverage of BS 102 in the communication system.

In some embodiments of the present disclosure, a Tx UE may support SL DRX and perform SL unicast transmission to an Rx UE which is an SL DRX enabled UE. In the SL unicast communication between the Tx UE and the Rx UE, there are two signaling exchanges for SL DRX configuration as follows:
signaling-1: signaling from the Rx UE to the Tx UE, which may be carried via a PC5 RRC message, and
signaling-2: signaling from the Tx UE to the Rx UE, which may be carried via a message (e.g., RRCReconfigurationSidelink) for delivering the SL DRX configuration.

When the Tx UE is in coverage of a serving network and in an RRC-connected state, the Tx UE may report the information (e.g., assistance information associated with the SL DRX configuration) received in signaling-1 to the serving network, and then obtain an SL DRX configuration from dedicated RRC signaling from the serving network to generate signaling-2.

When the Tx UE is in an RRC-idle state or RRC-inactive state, the Tx UE may acquire the SL DRX configuration based on a system information block (SIB) message received from the serving network. In an embodiment, the SIB message may include a set of SL DRX configurations each corresponding to a respective quality of service (QOS) profile. The Tx UE may determine the SL DRX configuration from the set of SL DRX configurations based on the assistance information received from the Rx UE. In another embodiment, the SIB message may include several common SL DRX configurations, and the Tx UE may determine the SL DRX configuration by itself from the several common SL DRX configurations based on the assistance information received from the Rx UE.

In some other embodiments, when the Tx UE is in the RRC-idle state or RRC-inactive state and receives the assistance information from the Rx UE, the Tx UE may request to enter in the RRC-connected state and transmit the received assistance information to the serving network for acquiring the SL DRX configuration.

When the Tx UE is out-of-coverage, the Tx UE may acquire the SL DRX configuration based on pre-configuration. In an embodiment, a set of SL DRX configurations each corresponding to a respective QoS profile may be pre-configured in the UE. The Tx UE may determine the SL DRX configuration from the set of SL DRX configurations based on the assistance information received from the Rx UE. In another embodiment, several common SL DRX configurations may be pre-configured in the UE, and the Tx UE may determine the SL DRX configuration by itself from the several common SL DRX configurations based on the assistance information received from the Rx UE.

When the Rx UE is in coverage of the serving network and in an RRC-connected state, the Rx UE may report the SL DRX configuration received in signaling-2 to the serving network.

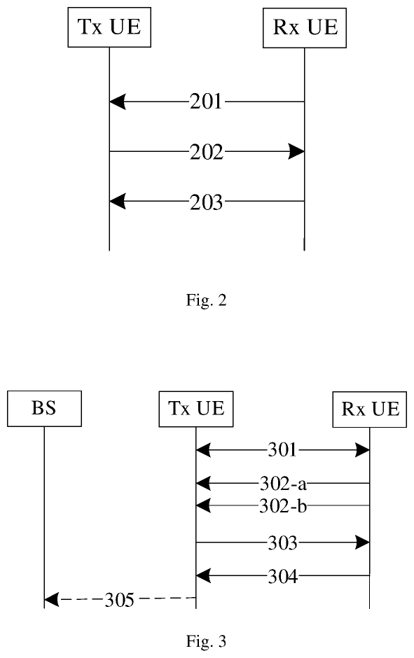

FIG. 2 illustrates a flow chart of an exemplary sidelink unicast communication between a Tx UE and an Rx UE according to some embodiments of the present disclosure. Both the Tx UE and the Rx UE support the SL DRX communication.

In step 201, the Rx UE transmits assistance information associated with an SL DRX configuration to the Tx UE. In some embodiments of the present disclosure, the Rx UE may transmit the assistance information in response to a request for the assistance information from the Tx UE. In some other embodiments of the present disclosure, the Rx UE may voluntarily transmit the assistance information to the Tx UE.

After receiving the assistance information, the Tx UE determines the SL DRX configuration based on the assistance information from the Rx UE, and in step 202, the Tx UE transmits the SL DRX configuration to the Rx UE. The SL DRX configuration may be included in an RRC reconfiguration message (e.g., RRCReconfigurationSidelink).

In step 203, the Rx UE transmits to the Tx UE a response related to whether the configuration(s) in the RRC reconfiguration message is (are) applicable. The response may include an RRC reconfiguration complete message (e.g., RRCReconfigurationCompletesidelink), which indicates that the configuration(s) in the RRC reconfiguration message is (are) applied to the Rx UE. The response may include an RRC reconfiguration failure message (e.g., RRCReconfigurationFailuresidelink), which indicates that at least one configuration in the RRC reconfiguration message is not applicable.

FIG. 3 illustrates a flow chart of another exemplary sidelink unicast communication between a Tx UE and an Rx UE according to some embodiments of the present disclosure. Both the Tx UE and the Rx UE support the SL DRX communication.

After receiving an indication from upper layer when it needs UE radio access capability information, in step 301, the Tx UE may transmit a request (e.g., UECapabilityEnquirySidelink) to the Rx UE, to request SL UE capability information of the Rx UE. The Rx UE may also transmit the request to the Tx UE, to request SL capability information of the Tx UE. The timing for transmitting the request is up to the Tx UE's implementation.

In step 302-a, the Rx UE may transmit the SL UE capability information of the Rx UE to the Tx UE, for example, via UECapabilityInformationSidelink. In step 302-b, the Rx UE may transmit the assistance information associated with the SL DRX configuration to the Tx UE.

In some embodiments, the assistance information is included in the SL UE capability information transmitted from the Rx UE to the Tx UE. That is, step 302-a and step 302-b are included in the same step. The assistance information included in the SL UE capability information may be a request for the SL DRX configuration, and the request may include one or more bits. Additionally or alternatively, the assistance information included in the SL UE capability information may include an indication of one or more pre-defined SL DRX configurations suggested or preferred by the Rx UE, and the indication may include one or more indexes of the one or more pre-defined SL DRX configurations.

In some other embodiments, the assistance information is transmitted separately from the SL UE capability information. That is, they are transmitted in two separate messages. For example, the assistance information can be carried in a PC5 RRC message transmitted after UECapabilityInformationSidelink.

In an embodiment of the present disclosure, in the case that the assistance information is transmitted separately from the SL UE capability information, the SL UE capability information may include an assistance information indicator, which indicates that the assistance information will be transmitted separately. When receiving the assistance information indicator in the SL UE capability information, the Tx UE can know that the assistance information will be transmitted from the Rx UE and may defer transmitting an RRC reconfiguration message to the Rx UE until it receives the assistance information from the Rx UE.

According to some embodiments of the present disclosure, the assistance information carried in signaling 1 from the Rx UE to the Tx UE, either transmitted in or separately from the SL UE capability information, may include at least one of the following:
a request to acquire an SL DRX configuration from the Tx UE, and the request may include one or more bits;
a Uu DRX configuration of the Rx UE;
one or more DRX configurations for other link(s) of the Rx UE, for example, an SL DRX configuration for a unicast link between the Rx UE and another UE;
one or more SL DRX configurations or parameters suggested or preferred by the Rx UE; or
an acceptance or a rejection of an SL DRX configurations received from the Tx UE.

Because the Rx UE's state and traffic information may change, the assistance information of the Rx UE may also change. Therefore, the assistance information of the Rx UE should be updated and transmitted to the Tx UE correspondingly, and the SL DRX configuration also needs to be adjusted due to the updated assistance information.

In some embodiments, the Rx UE transmits the assistance information to the Tx UE periodically.

In some other embodiments, the Rx UE transmits the assistance information to the Tx UE when the Rx UE has one or more preferred SL DRX configurations or preferred DRX parameters.

In some other embodiments, the Rx UE transmits the assistance information to the Tx UE when the assistance information is updated.

In some other embodiments, the Rx UE transmits the assistance information to Tx UE when the Rx UE performs a state transition (i.e., when an operating state of the Rx UE changes), for example, between an RRC-connected state and an RRC-idle state or RRC-inactive state, or between in-coverage and out-of-coverage.

In some other embodiments, the Rx UE transmits the assistance information to the Tx UE when the Rx UE receives a request for the assistance information from the Tx UE. The request may include an indication to request assistance information associated with an SL DRX configuration from the Rx UE. The indication may include one or more bits. Additionally or alternatively, the request may include one or more SL DRX configurations, which are suggested by the Tx UE. The timing for transmitting the request is up to the Tx UE's implementation.

After receiving the assistance information from the Rx UE, the Tx UE may determine an SL DRX configuration based on the assistance information. In step 303, the Tx UE may transmit the determined SL DRX configuration to the Rx UE. The SL DRX configuration may be included in an RRC reconfiguration message transmitted from the Tx UE to the Rx UE, e.g., RRCReconfigurationSidelink.

In step 304, the Rx UE may transmit a response to the Tx UE related to whether the SL DRX configuration received from the Tx UE is applicable.

In the present disclosure, an SL DRX configuration failure indication is introduced to indicate a failure of applying the SL DRX configuration at the Rx UE's side. Specifically, when the Rx UE rejects the SL DRX configuration received from the Tx UE, or the Rx UE is unable to apply the SL DRX configuration, the Rx UE may transmit to the Tx UE an RRC reconfiguration failure message (e.g., RRCReconfigurationFailuresidelink) with an SL DRX configuration failure indication. In some embodiments, the SL DRX configuration failure indication is included in the RRC reconfiguration failure message. In some other embodiments, the SL DRX configuration failure indication is included in a message transmitted along with the RRC reconfiguration failure message.

In an embodiment, the SL DRX configuration failure indication from the Rx UE may include a cause for the SL DRX configuration failure. In another embodiment, the Rx UE may transmit updated assistance information along with the SL DRX configuration failure indication to the Tx UE, such that the Tx UE may determine and transmit an updated SL DRX configuration based on the updated assistance information.

The RRC reconfiguration message including the SL DRX configuration may further include one or more AS configurations. Regarding the application of the SL DRX configuration and the one or more AS configurations at the Rx UE, there are four scenarios as described in Table 1 below.

TABLE 1

| | | | | apply | |
|---|---|---|---|---|---|
| | SL DRX | AS | | SL DRX | AS |
| | config- | config- | | config- | config- |
| | uration | urations | response | uration | urations |
| 1 | ✓ | ✓ | RRC | ✓ | ✓ |
| | | | reconfiguration | | |
| | | | complete | | |
| | | | message | | |
| 2 | x | ✓ | RRC | Option 1 | |
| | | | reconfiguration | x | ✓ |
| | | | failure | Option 2 | |
| | | | message with | x | x |
| | | | SL DRX | | |
| | | | configuration | | |
| | | | failure | | |
| | | | indication | | |
| 3 | ✓ | x | RRC | Option 1 | |
| | | | reconfiguration | ✓ | x |
| | | | failure | Option 2 | |
| | | | message without | x | x |
| | | | SL DRX | | |
| | | | configuration | | |
| | | | failure | | |
| | | | indication | | |
| 4 | x | x | RRC | x | x |
| | | | reconfiguration | | |
| | | | failure | | |
| | | | message with | | |
| | | | SL DRX | | |
| | | | configuration | | |
| | | | failure | | |
| | | | indication | | |

Scenario 1: both the SL DRX configuration and the one or more AS configurations received from the Tx UE are applicable to the Rx UE. In this case, the response of the Rx UE transmitted in step 304 is an RRC reconfiguration complete message (e.g., RRCReconfigurationCompletesidelink). The Rx UE applies both the received SL DRX configuration and the received one or more AS configurations.

Scenario 2: the received SL DRX configuration is not applicable while the received one or more AS configurations are applicable to the Rx UE. In this case, the response of the Rx UE transmitted in step 304 is an RRC reconfiguration failure message (e.g., RRCReconfigurationFailuresidelink) with an SL DRX configuration failure indication. In this case, the Rx UE may take one of the following two options:
Option 1: the Rx UE applies the received one or more AS configurations, and does not apply the received SL DRX configuration. The Rx UE may continue to apply a previous SL DRX configuration until a new SL DRX configuration is received. In some embodiments, the new SL DRX configuration is included in a new RRC reconfiguration message.
Option 2: the Rx UE does not apply the received one or more AS configurations or the received SL DRX configuration. The Rx UE may continue to apply a previous SL DRX configuration and previous one or more AS configurations until a new RRC reconfiguration message is received.

Scenario 3: the received SL DRX configuration is applicable while the received one or more AS configurations are not applicable to the Rx UE. In this case, the response of the Rx UE transmitted in step 304 is an RRC reconfiguration failure message (e.g., RRCReconfigurationFailuresidelink) without an SL DRX configuration failure indication. In this case, the Rx UE may take one of the following two options:
Option 1: the Rx UE applies the received SL DRX configuration, and does not apply the received one or more AS configurations. The Rx UE may continue to apply previous one or more AS configurations until new AS configuration(s) is (are) received. In some embodiments, the new AS configuration(s) is (are) included in a new RRC reconfiguration message.
Option 2: the Rx UE does not apply the received one or more AS configurations or the received SL DRX configuration. The Rx UE may continue to apply a previous SL DRX configuration and previous one or more AS configurations until a new RRC reconfiguration message is received.

Scenario 4: neither the received SL DRX configuration nor the received one or more AS configurations are applicable. In this case, the response of the Rx UE transmitted in step 304 is an RRC reconfiguration failure message (e.g., RRCReconfigurationFailuresidelink) with an SL DRX configuration failure indication. In this case, the Rx UE may continue to apply a previous SL DRX configuration and previous one or more AS configurations until a new RRC reconfiguration message is received.

In scenarios 2 and 4, after receiving the SL DRX configuration failure indication from the Rx UE, if the Tx UE is in the RRC-connected state, in step 305, the Tx UE may transmit a report to a serving BS. The report may use the same format as the report of the Tx UE for reporting the assistance information received in signaling-1 to the serving BS. The report may include at least one of the following information: an SL DRX configuration failure indication, the failure cause received from the Rx UE, and/or the updated assistance information from the Rx UE.

In some other embodiments, the SL DRX configuration failure indication is not introduced. When the Rx UE rejects any one of the AS configurations and the SL DRX configuration received from the Tx UE, or the Rx UE is unable to apply any one of the AS configurations and the SL DRX configuration, the Rx UE may transmit to the Tx UE the RRC reconfiguration failure message (e.g., RRCReconfiguration Failuresidelink), and continue using the previous one or more AS configurations and the previous SL DRX configuration.

After receiving the RRC reconfiguration failure message, the Tx UE may reconfigure the one or more AS configurations and the SL DRX configuration, and transmit the new RRC configuration message, which includes the new one or more AS configurations and the new SL DRX configuration, to the Tx UE.

A UE's state may change due to the UE's movement. For example, the UE may perform any of the following state transitions:
Case 1: from the RRC-connected state to the RRC-idle state or RRC-inactive state;
Case 2: from in-coverage to out-of-coverage;
Case 3: from the RRC-idle state or RRC-inactive state to the RRC-connected state;
Case 4: from out-of-coverage to in-coverage;
Case 5: from the RRC-idle state to the RRC-inactive state; and
Case 6: from the RRC-inactive state to the RRC-idle state.

The SL DRX configuration may need to be updated when the Tx UE or Rx UE performs one of the state transitions.

When the Tx UE performs the state transition, the Tx UE acquires new SL DRX configuration(s) in the new state, determines a new SL DRX configuration and transmits the new SL DRX configuration to the Rx UE.

At the Rx UE side, before receiving the new SL DRX configuration, the Rx UE applies the SL DRX configuration provided in the old state. After receiving the new SL DRX configuration in the new state, the Rx UE applies the new SL DRX configuration if the new SL DRX configuration is applicable. If the new SL DRX configuration is not applicable, the Rx UE may continue to apply the SL DRX configuration provided in the old state and transmit a response to the Tx UE in a manner similar to that described with respect to step 304, and the Tx UE may determine an updated SL DRX configuration based on the response of the Rx UE.

According to some embodiments, when the Tx UE enters in a new state, it may acquires new SL DRX configuration(s) in the new state, determine and transmit a new SL DRX configuration to the Rx UE without receiving assistance information from the Rx UE.

According to some other embodiments, when the Tx UE enters in a new state, it may transmit an indication to the Rx UE to request for assistance information, and then determine a new SL DRX configuration in the new state based on the assistance information received from the Rx UE and transmit the new SL DRX configuration to the Rx UE.

When the Rx UE performs the state transition, the Rx UE determines updated assistance information in the new state, and transmits updated assistance information to the Tx UE. In some embodiments, the updated assistance information may indicate the state transition of the Rx UE.

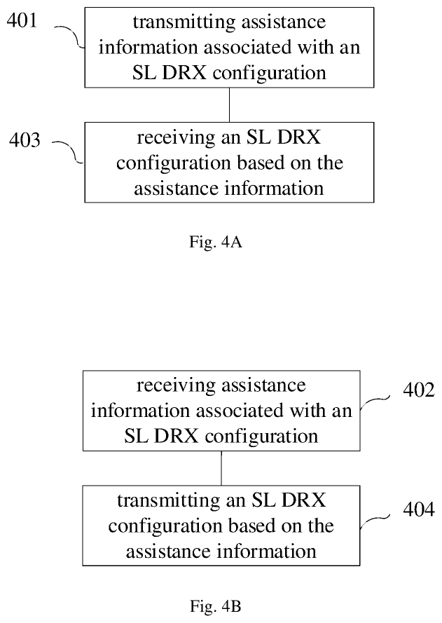

FIG. 4A illustrates a flow chart of an exemplary method performed by an Rx UE for wireless communication according to some embodiments of the present disclosure.

In step 401, the Rx UE transmits assistance information associated with an SL DRX configuration of the Rx UE to a Tx UE. The assistance information may be transmitted in an SL UE capability information message (e.g., UECapabilityInformationSidelink) indicating an SL UE capability of the Rx UE, or transmitted in a separate RRC message, which is separately transmitted from the SL UE capability information message.

In step 403, the Rx UE receives an SL DRX configuration based on the assistance information from the Tx UE that was sent to the Tx UE.

The assistance information includes at least one of the following:
a request for the SL DRX configuration;
a Uu DRX configuration of the Rx UE;
one or more DRX configurations for one or more other links of the Rx UE;
one or more SL DRX configurations preferred or suggested by the Rx UE; or
an acceptance or a rejection of an SL DRX configuration received from the Tx UE.

In some embodiments, the assistance information is transmitted periodically. In some other embodiments, the assistance information is transmitted when the Rx UE has one or more preferred SL DRX configurations, when the assistance information of the Rx UE is updated, when an operating state of the Rx UE changes, or when the Rx UE receives a request for the assistance information from the Tx UE.

In some embodiments, the request for the assistance information includes a one-bit indication or a list of DRX configurations suggested or preferred by the Tx UE.

In some embodiments, the assistance information included in the SL UE capability information message of the Rx UE includes a one-bit request for the SL DRX configuration, or an index of an SL DRX configuration suggested by the Rx UE.

In some embodiments, the SL UE capability information message includes an assistance information indicator indicating that the assistance information is to be transmitted in the separate RRC message.

After receiving the SL DRX configuration from the Tx UE, which is transmitted along with one or more AS configurations, or separately from the one or more AS configurations, the Rx UE determines whether the SL DRX configuration and the one or more AS configurations are applicable or not, and performs different operations as follows based on the determined results.

In the case that the SL DRX configuration is not applicable and the one or more AS configurations received with the SL DRX configuration are applicable (i.e., the scenario 2 in Table 1), the Rx UE transmits, to the Tx UE, an RRC reconfiguration failure message with an SL DRX configuration failure indication. The SL DRX configuration failure indication may include an SL DRX configuration failure cause.

The Rx UE then may apply a previous SL DRX configuration until a new RRC reconfiguration message is received, and apply the one or more AS configurations or continue to apply previous one or more AS configurations until a new RRC reconfiguration message is received. The Rx UE may receive, from the Tx UE, an updated SL DRX configuration in response to the SL DRX configuration failure indication

In the case that the SL DRX configuration is applicable and one or more AS configurations received with the SL DRX configuration are not applicable (i.e., the scenario 3 in Table 1), the Rx UE transmits, to the Tx UE, an RRC reconfiguration failure message without an SL DRX configuration failure indication.

The Rx UE then may apply previous one or more AS configurations until a new RRC reconfiguration message is received, and apply the SL DRX configuration or continue to apply a previous SL DRX configuration until a new RRC reconfiguration message is received.

In the case that the SL DRX configuration is not applicable and one or more AS configurations received with the SL DRX configuration are not applicable (i.e., the scenario 4 in Table 1), the Rx UE transmits, to the Tx UE, an RRC reconfiguration failure message with an SL DRX configuration failure indication, and continues to apply a previous SL DRX configuration and previous one or more AS configurations until a new RRC reconfiguration message is received. The SL DRX configuration failure indication may include an SL DRX configuration failure cause. The Rx UE may receive, from the Tx UE, an updated SL DRX configuration in response to the SL DRX configuration failure indication.

In the case that the SL DRX configuration is applicable and one or more AS configurations received with the SL DRX configuration are applicable (i.e., the scenario 1 in Table 1), the Rx UE transmits, to the Tx UE, an RRC reconfiguration complete message, and applies both the SL DRX configuration and the one or more AS configurations.

In some embodiments, the Rx UE may transmit, to the Tx UE, updated assistance information in the case that the SL DRX configuration is not applicable.

FIG. 4B illustrates a flow chart of an exemplary method performed by a Tx UE for wireless communication according to some embodiments of the present disclosure, which corresponds to that illustrated in FIG. 4A.

In step 402, the Tx UE receives assistance information associated with an SL DRX configuration of an Rx UE, from the Rx UE. The assistance information may be received in an SL UE capability information message (e.g., UECapabilityInformationSidelink) indicating an SL UE capability of the Rx UE, or received in a separate RRC message, which is separately transmitted from the SL UE capability information message.

In step 404, the Tx UE transmits an SL DRX configuration based on the assistance information that was received from the Rx UE, to the Rx UE.

The assistance information includes at least one of the following:
a request for the SL DRX configuration;
a Uu DRX configuration of the Rx UE;
one or more DRX configurations for one or more other links of the Rx UE;
one or more SL DRX configurations preferred or suggested by the Rx UE; or
an acceptance or a rejection of an SL DRX configuration received from the Tx UE.

In some embodiments, the assistance information is received periodically.

In some embodiments, the Tx UE may transmit a request for the assistance information to the Rx UE. The request for the assistance information includes a one-bit indication or a list of DRX configurations suggested or preferred by the Tx UE.

In some embodiments, the assistance information included in the SL UE capability information message of the Rx UE includes a one-bit request for the SL DRX configuration, or an index of an SL DRX configuration suggested by the Rx UE.

In some embodiments, the SL UE capability information message includes an assistance information indicator indicating that the assistance information is to be received in the separate RRC message.

In some embodiments, the Tx UE receives, from the Rx UE, an SL DRX configuration failure indication, and transmits an updated SL DRX configuration to the Rx UE in response to the SL DRX configuration failure indication.

In some embodiments, the Tx UE may transmit, to a BS, at least one of the following: updated assistance information from the Rx UE; the SL DRX configuration failure indication; or an SL DRX configuration failure cause. The SL DRX configuration failure indication received from the Rx UE may include the SL DRX configuration failure cause.

When an operating state of the Tx UE changes, the Tx UE may transmit the request for the assistance information to the Rx UE. The Tx UE may acquire an updated SL DRX configuration when its state changes, and transmit the updated SL DRX configuration to the Rx UE when the updated SL DRX configuration is acquired.

In some embodiments, the Tx UE may transmit to a BS the assistance information received from the Rx UE to request the SL DRX configuration, and receive the SL DRX configuration from the BS.

In some embodiments, the Tx UE may determine the SL DRX configuration from a set of SL DRX configurations each corresponding to a respective QoS profile, or from a set of common SL DRX configurations. For example, when the Tx UE is in the RRC-idle state or in the RRC-inactive state, the Tx UE may determine the SL DRX configuration from a set of common SL DRX configurations. The set of SL DRX configurations or the set of common SL DRX configurations are preconfigured in the Tx UE or received in a SIB message.

In some embodiments, upon receiving the assistance information from the Rx UE, if the Tx UE is in an RRC-idle state or an RRC-inactive state, the Tx UE may request to enter in an RRC-connected state.

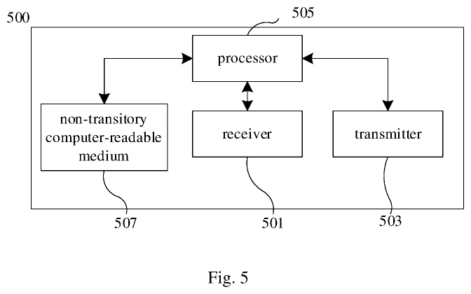

FIG. 5 illustrates a simplified block diagram of an exemplary apparatus 500 according to some embodiments of the present application. The apparatus 500 may be or include at least a part of a UE (e.g., the UE 101-A, UE 101-B, UE 101-C, or UE 101-D as illustrated in FIG. 1, or the Tx UE or the Rx UE as illustrated in FIG. 2 or FIG. 3) or other device with similar functionality.

As shown in FIG. 5, the apparatus 500 may include a receiver 501, a transmitter 503, a processer 505, and a non-transitory computer-readable medium 507. The non-transitory computer-readable medium 507 has computer executable instructions stored therein. The processer 505 is configured to be coupled with the non-transitory computer readable medium 507, the receiver 501, and the transmitter 503. It can be contemplated that, in some other embodiments of the present application, the apparatus 500 may include more computer-readable mediums, receivers, transmitters and processors according to practical requirements. In some embodiments of the present application, the receiver 501 and the transmitter 503 can be a wireless receiver and a wireless transmitter, respectively, and can be integrated into a single device, such as a wireless transceiver. In certain embodiments, the apparatus 500 may further include an input device, a memory, and/or other components.

In some embodiments of the present application, the non-transitory computer-readable medium 507 may have stored thereon computer-executable instructions to cause the processor 505 to implement the method performed by the Tx UE or the Rx UE according to any embodiment of the present application, e.g., the method illustrated in FIG. 2, 3, 4A, or 4B.

For example, the processor 505 may be configured to transmit, via the transmitter 503, assistance information associated with an SL DRX configuration, wherein the assistance information is transmitted in an SL UE capability information message indicating an SL UE capability of the apparatus 500, or transmitted separately from the SL UE capability information message. The processor 505 may be further configured to receive, via the receiver 501, an SL DRX configuration determined based on the assistance information.

For example, the processor 505 may be configured to receive, from a second apparatus via the receiver 501, assistance information associated with an SL DRX configuration, wherein the assistance information is received in an SL UE capability information message indicating an SL UE capability of the second apparatus, or received separately from the SL UE capability information message. The processor 505 may be further configured to transmit, via the transmitter 503, an SL DRX configuration determined based on the assistance information.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “including.”

1. A method performed by a first user equipment (UE), the method comprising:
transmitting, to a second UE, assistance information associated with a sidelink (SL) discontinuous reception (DRX) configuration of the first UE, wherein the assistance information is comprised in an SL UE capability information message of the first UE that is also transmitted to the second UE, or comprised in a separate radio resource control (RRC) message that is also transmitted to the second UE; and
receiving, from the second UE, an SL DRX configuration to be used based on the assistance information that was sent to the second UE.

2. The method of claim 1, wherein the assistance information comprises at least one of the following:
a request for the SL DRX configuration;
a Uu DRX configuration of the first UE;
one or more DRX configurations for one or more other links of the first UE;
one or more desired SL DRX configurations by the first UE; or
an acceptance or a rejection of an SL DRX configuration received from the second UE.

3. The method of claim 1, wherein the assistance information is transmitted in at least one of the following cases:
when the first UE has one or more preferred SL DRX configurations;
when the assistance information of the first UE is updated or changed;
when an operating state of the first UE changes; or
when the first UE receives a request for the assistance information from the second UE.

4. The method of claim 1, wherein the assistance information in the SL UE capability information message of the first UE comprises a one-bit request for the SL DRX configuration, or an index of an SL DRX configuration suggested by the first UE.

5. The method of claim 1, wherein the SL UE capability information message of the first UE comprises an assistance information indicator indicating that the assistance information is to be transmitted in the separate RRC message.

6. The method of claim 1, further comprising:
in response to the SL DRX configuration not being applicable and one or more access stratum (AS) configurations received with the SL DRX configuration being applicable:
transmitting, to the second UE, an RRC reconfiguration failure message with an SL DRX configuration failure indication or reject indication;
applying a previous SL DRX configuration until a new RRC reconfiguration message is received; and
applying the one or more AS configurations or continuing to apply previous one or more AS configurations until a new RRC reconfiguration message is received.

7. The method of claim 1, further comprising:
in response to the SL DRX configuration being applicable and one or more AS configurations received with the SL DRX configuration are not applicable:
transmitting, to the second UE, an RRC reconfiguration failure message without an SL DRX configuration failure indication or reject indication;
applying previous one or more AS configurations until a new RRC reconfiguration message is received; and
applying the SL DRX configuration or continuing using a previous SL DRX configuration until a new RRC reconfiguration message is received.

8. The method of claim 1, further comprising:
in response to the SL DRX configuration not being applicable and one or more AS configurations received with the SL DRX configuration not being applicable:
transmitting, to the second UE, an RRC reconfiguration failure message with an SL DRX configuration failure indication or reject indication; and
continuing using a previous SL DRX configuration and previous one or more AS configurations until a new RRC reconfiguration message is received.

9. A method performed by a second user equipment (UE), the method comprising:
receiving, from a first UE, assistance information associated with a sidelink (SL) discontinuous reception (DRX) configuration of the first UE, wherein the assistance information is comprised in an SL UE capability information message of the first UE that is also received from the first UE, or in a separate radio resource control (RRC) message that is also received from the first UE;
determining a SL DRX configuration based on the assistance information received from the first UE; and
transmitting, to the first UE, an SL DRX configuration to be used for the first UE.

10. The method of claim 9, further comprising:
transmitting, to a base station (BS), at least one of the following:
updated assistance information from the first UE;
the SL DRX configuration failure indication; or
an SL DRX configuration failure cause.

11. The method of claim 9, further comprising transmitting a request for the assistance information to the first UE, wherein the request for the assistance information is transmitted when an operating state of the second UE changes.

12. The method of claim 9, further comprising:
acquiring an updated SL DRX configuration when an operating state of the second UE changes; and
transmitting the updated SL DRX configuration to the first UE when the updated SL DRX configuration is acquired.

13. The method of claim 9, further comprising requesting to enter in an RRC-connected state upon receiving the assistance information in response to the second UE being in an RRC-idle state or an RRC-inactive state.

14. A first user equipment (UE), comprising:
at least one memory; and
at least one processor coupled with the at least one memory and configured to cause the first UE to:
transmit, via the wireless transceiver, assistance information associated with a sidelink (SL) discontinuous reception (DRX) configuration of the first UE, wherein the assistance information is comprised in an SL UE capability information message of the first UE that is also transmitted to the second UE, or comprised in a separate radio resource control (RRC) message that is also transmitted to the second UE; and
receive, via the wireless transceiver, an SL DRX configuration to be used based on the assistance information that was sent to the second UE.

15. A second user equipment (UE), comprising:
at least one memory; and
at least one processor coupled with the at least one memory and configured to cause the second UE to:
receive, from a first UE, assistance information associated with a sidelink (SL) discontinuous reception (DRX) configuration of the first UE, wherein the assistance information is in an SL UE capability information message of the first UE that is also received from the first UE, or in a separate radio resource control (RRC) message that is also received from the first UE;
determine a SL DRX configuration based on the assistance information received from the first UE; and
transmit, to the first UE, an SL DRX configuration to be used for the first UE.

16. The second UE of claim 15, wherein the at least one processor is configured to cause the second UE to:
transmit, to a base station (BS), at least one of the following:
updated assistance information from the first UE;
the SL DRX configuration failure indication; or
an SL DRX configuration failure cause.

17. The second UE of claim 15, wherein the at least one processor is configured to cause the second UE to transmit a request for the assistance information to the first UE, wherein the request for the assistance information is transmitted when an operating state of the second UE changes.

18. The second UE of claim 15, wherein the at least one processor is configured to cause the second UE to:
acquire an updated SL DRX configuration when an operating state of the second UE changes; and
transmit the updated SL DRX configuration to the first UE when the updated SL DRX configuration is acquired.

19. The second UE of claim 15, wherein the at least one processor is configured to cause the second UE to request to enter in an RRC-connected state upon receiving the assistance information in response to the second UE being in an RRC-idle state or an RRC-inactive state.

20. The method of claim 1, further comprising:
in response to the SL DRX configuration being applicable or accepted and one or more AS configurations received with the SL DRX configuration are applicable or accepted:
transmitting, to the second UE, an RRC reconfiguration complete message; and
applying both the SL DRX configuration and the one or more AS configurations.
